(19) United States
(12) Patent Application Publication
(10) Pub. No.: US 2017/0318369 A1
(43) Pub. Date: Nov. 2, 2017

(54) EAR-HOOK MICROPHONE AND EAR-HOOK DEVICE THEREOF

(71) Applicant: NEATRON CORPORATION, Taipei City (TW)

(72) Inventor: Jung-Kun WANG, Taipei City (TW)

(73) Assignee: NEATRON CORPORATION, Taipei City (TW)

(21) Appl. No.: 15/142,685

(22) Filed: Apr. 29, 2016

(51) Int. Cl. H04R 1/10; H04R 1/08

(52) U.S. Cl. CPC H04R 1/105; H04R 1/08; H04R 1/1066

(57) ABSTRACT

Provided is an ear-hook device, and the ear-hook device comprises an ear-hook part and a connecting part. The ear-hook part comprises a first wire and a second wire adjacent to the first wire. One end of the first wire is connected to one end of the second wire, and the other end of the first wire penetrates into the connecting part. Provided is also an ear-hook microphone, and the ear-hook microphone comprises the ear-hook device, a guide rod and a microphone. The guide rod is positioned between the ear-hook device and the microphone. The first wire and the second wire are positioned to respectively abut against the user's ear back and head, allowing the ear-hook device to be hung on the user's ear more stably and the pressure pressed on the user's ear to be distributed.

### BACKGROUND OF THE INVENTION

### 1. Field of the Invention

The present invention relates to an ear-hook device, especially to the ear-hook device used in an ear-hook microphone. The present invention also relates to the ear-hook microphone comprising the ear-hook device.

### 2. Description of the Prior Art

With the advance of technology and living standards, high-tech products have been widely used in everyday lives. For example, hands-free microphones have replaced handheld microphones and have been used by public speakers and mobile phone users.

With reference to FIG. 15, a conventional hands-free microphone comprises a hook portion 60, a supporting portion 70, a thin rod 80 and a microphone 90. One end of the hook portion 60 is connected to the supporting portion 70, and the thin rod 80 is connected to the other end of the hook portion 60 opposite to the supporting portion 70. The hook portion 60 is formed in a C shape and comprises a wire 61 within the hook portion 60. The wire 61 is threaded into one end of the supporting portion 70. The thin rod 80 is connected to the wire 61 opposite to the supporting portion 70, and the microphone 90 is connected to the thin rod 80 opposite to the wire 61. The user can hang the hook portion 60 on the user's ear, making the hook portion 60 abut against the user's ear back. Then, the user can adjust the position of the thin rod 80 and the microphone 90 close to the mouth of the user.

With reference to FIG. 16, another conventional hands-free microphone is similar to the conventional hands-free microphone shown in FIG. 15. The differences between the two conventional hands-free microphones include that the supporting portion 70A of the conventional hands-frees microphone shown in FIG. 16 further comprises a connecting end 71A, and one end of the thin rod 80A is connected to the connecting end 71A of the supporting portion 70A. However, when the user hangs any of the two conventional hands-free microphones on the ear and moves the body, any of the two conventional hands-free microphones is easy to drop from the ear. Besides, the hook portion 60A pressed on the ear back causes pain of the ear back as the conventional hands-free microphones are kept hanging on the ear for a long time.

### SUMMARY OF THE INVENTION

To overcome the shortcomings, the main objective of the present invention provides an ear-hook microphone and an ear-hook device thereof to mitigate or obviate the aforementioned problems.

The ear-hook device in accordance with the present invention comprises an ear-hook part and a connecting part. The ear-hook part comprises a first wire having two ends, a second wire having two ends, a first end and a second end. The second wire is adjacent to the first wire. The first end is formed by connecting one of the ends of the first wire to one of the ends of the second wire of the ear-hook part. The first end of the ear-hook part is able to be bent into an arc-shaped and hooked form. The second end is formed by extending from the other end of the first wire opposite to the first end. The connecting part comprises a penetration end, and the penetration end is penetrated by the second end of the ear-hook part.

Preferably, the first wire of the ear-hook part is overlapped with the second wire of the ear-hook part.

Preferably, the two ends of the first wire of the ear-hook part are each respectively connected to the two ends of the second wire of the ear-hook part.

Preferably, the second end of the ear-hook part is coated by the connecting part.

Preferably, the second end of the ear-hook part is not coated by the connecting part.

Preferably, the materials of the first wire and the second wire of the ear-hook part are flexible metal.

Preferably, the ear-hook device in accordance with the present invention further comprises a wire cover; the wire cover respectively coats the first wire, the second wire, the first end and the second end of the ear-hook part.

Preferably, the material of the wire cover is silicone.

Preferably, the connecting part further comprises a connecting end, and the connecting end is adjacent to the penetration end of the connecting part.

The ear-hook microphone in accordance with the present invention comprises the ear-hook device, a guide rod and a microphone. The microphone is connected to one end of the guide rod, and the other end of the guide rod opposite to the microphone is connected to the first end of the ear-hook part of the ear-hook device. In another embodiment, the microphone is connected to one end of the guide rod, and the other end of the guide rod opposite to the microphone is connected to the connecting end of the connecting part of the ear-hook device.

As a user uses the ear-hook microphone and the ear-hook device thereof, the user pulls the first wire away from the second wire of the ear-hook part and hangs the first end of the ear-hook part on the user's ear, allowing the first wire coated with the wire cover and the second wire coated with the wire cover respectively to abut against the user's ear back and head. Therefore, the ear-hook microphone can be hung on the user's ear more stably by increasing the contact areas between the first wire and user's ear back, as well as between the second wire of the ear-hook part and the user's head. Besides, the pressure pressed on the user's ear back by the ear-hook part is distributed. Therefore, the problems of wearing instability and pain caused by wearing the hands-free microphones for a long time will be solved.

### BRIEF DESCRIPTION OF THE DRAWINGS

FIG. 1 is a perspective view of a first embodiment of an ear-hook microphone and an ear-hook device thereof in accordance with the present invention;

FIG. 2 is a cross-sectional view of a first wire and a second wire of the ear-hook device in FIG. 1;

FIG. 3 is another perspective view of the first embodiment of the ear-hook microphone and the ear-hook device thereof in FIG. 1;

FIG. 4 is still another perspective view of the first embodiment of the ear-hook microphone and the ear-hook device thereof in FIG. 1;

FIG. 5 is a perspective view of a second embodiment of the ear-hook microphone and the ear-hook device thereof in accordance with the present invention;

FIG. 6 is another perspective view of the second embodiment of the ear-hook microphone and the ear-hook device thereof in FIG. 5;

FIG. 7 is still another perspective view of the second embodiment of the ear-hook microphone and the ear-hook device thereof in FIG. 5;

FIG. 8 is a perspective view of a third embodiment of the ear-hook microphone and the ear-hook device thereof in accordance with the present invention;

FIG. 9 is another perspective view of the third embodiment of the ear-hook microphone and the ear-hook device thereof in FIG. 8;

FIG. 10 is a perspective view of a fourth embodiment of the ear-hook microphone and the ear-hook device thereof in accordance with the present invention;

FIG. 11 is a perspective view of a fifth embodiment of the ear-hook microphone and the ear-hook device thereof in accordance with the present invention;

FIG. 12 is another perspective view of the fifth embodiment of the ear-hook microphone and the ear-hook device thereof in accordance with the present invention;

FIG. 13 is a perspective view of a sixth embodiment of the ear-hook microphone and the ear-hook device thereof in accordance with the present invention;

FIG. 14 is a perspective view of a seventh embodiment of the ear-hook microphone and the ear-hook device thereof in accordance with the present invention;

FIG. 15 is a perspective view of a conventional hands-free microphone; and

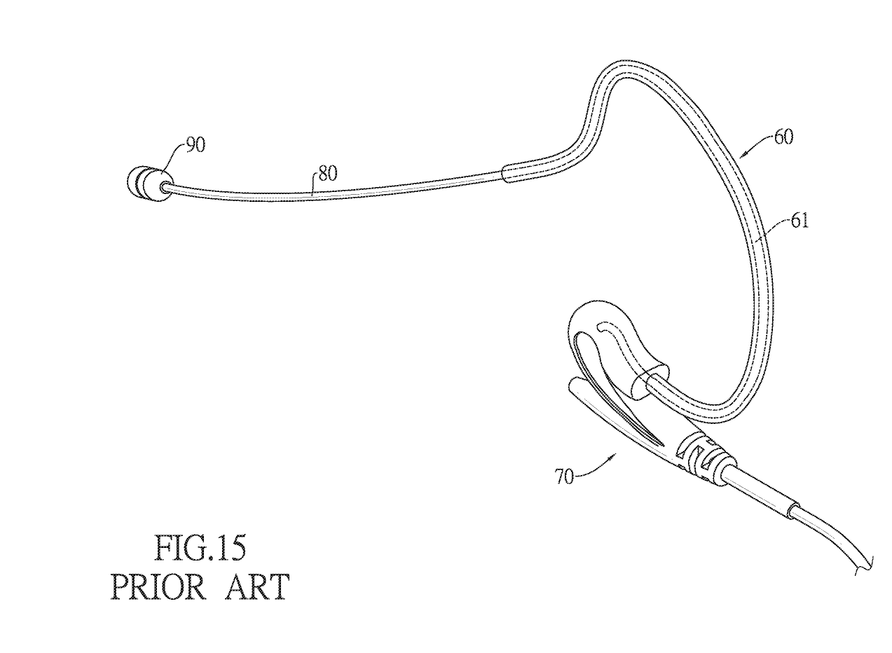

FIG. 16 is a perspective view of another conventional hands-free microphone.

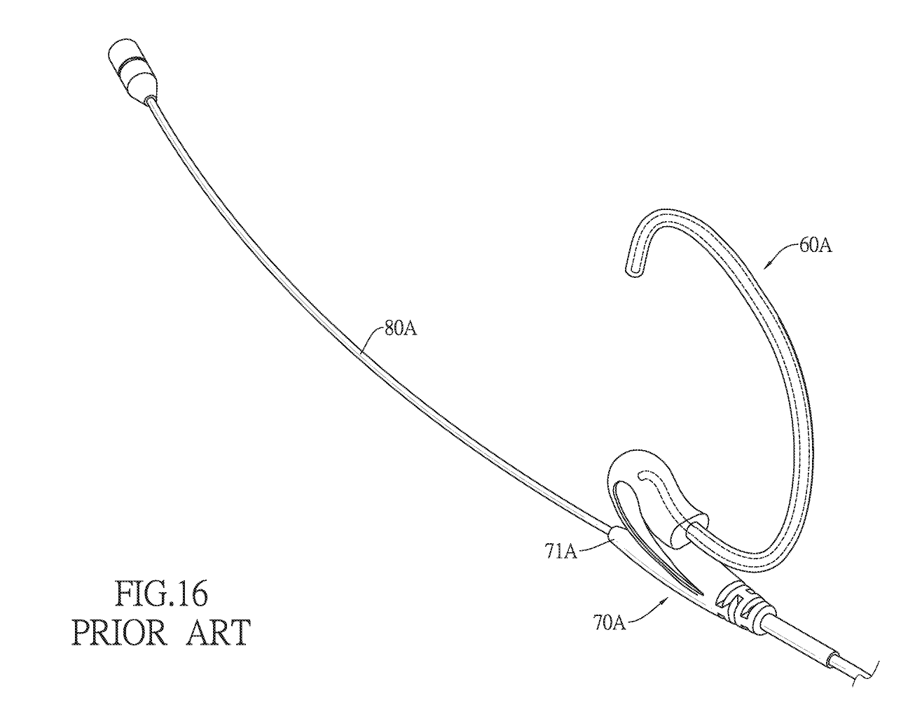

### DETAILED DESCRIPTION OF THE PREFERRED EMBODIMENTS

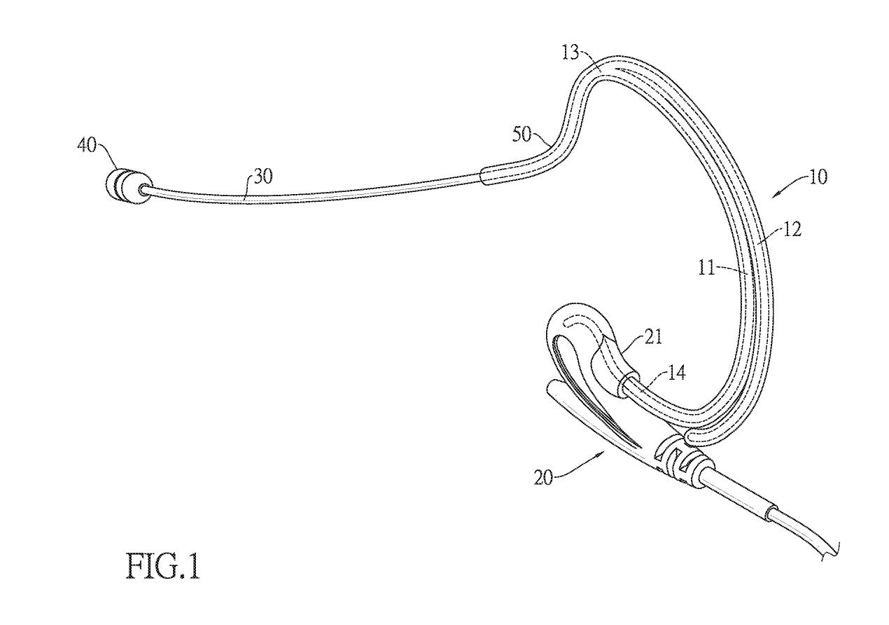

With reference to FIG. 1, a first embodiment of the ear-hook device in accordance with the present invention comprises an ear-hook part 10 and a connecting part 20.

The ear-hook part 10 is formed in a C shape and corresponding to the contour of a human ear. The ear-hook part 10 comprises a first wire 11 having two ends and a second wire 12 having two ends. The second wire 12 is adjacent to the first wire 11, and one end of the first wire 11 is connected to one of the ends of the second wire 12 to form a first end 13 of the ear-hook part 10. The first end 13 of the ear-hook part 10 is able to be bent into an arc-shaped and hooked form corresponding to the contour of a user's ear. The other end of the first wire 11 opposite to the first end 13 is extended to form a second end 14 of the ear-hook part 10. In an embodiment, the first wire 11 is overlapped with the second wire 12, and the materials of the first wire 11 and the second wire 12 of the ear-hook part 10 are flexible metal.

The connecting part 20 comprises a penetration end 21. The penetration end 21 is penetrated by the second end 14 of the ear-hook part 10 and the second end 14 of the ear-hook part 10 is coated by the connecting part 20.

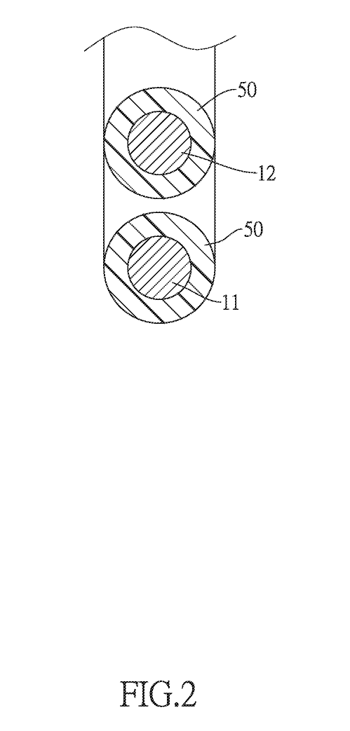

With reference to FIG. 1, the first embodiment of the ear-hook microphone in accordance with the present invention comprises the ear-hook device, a guide rod 30, a microphone 40 and a wire cover 50. One end of the guide rod 30 is connected to the first end 13 of the ear-hook part 10 of the ear-hook device, and the microphone 40 is connected to the other end of the guide rod 30 opposite to the first end 13 of the ear-hook part 10. With references to FIGS. 1 and 2, the wire cover 50 respectively coats the first wire 11, the second wire 12 and the first end 13 of the ear-hook part 10. In an embodiment, the material of the wire cover 50 is silicone.

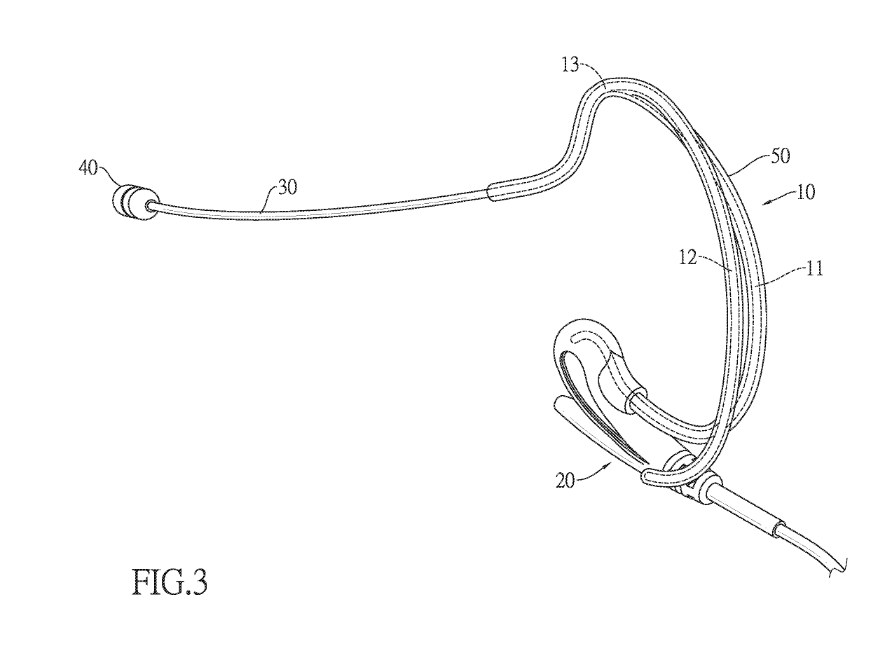

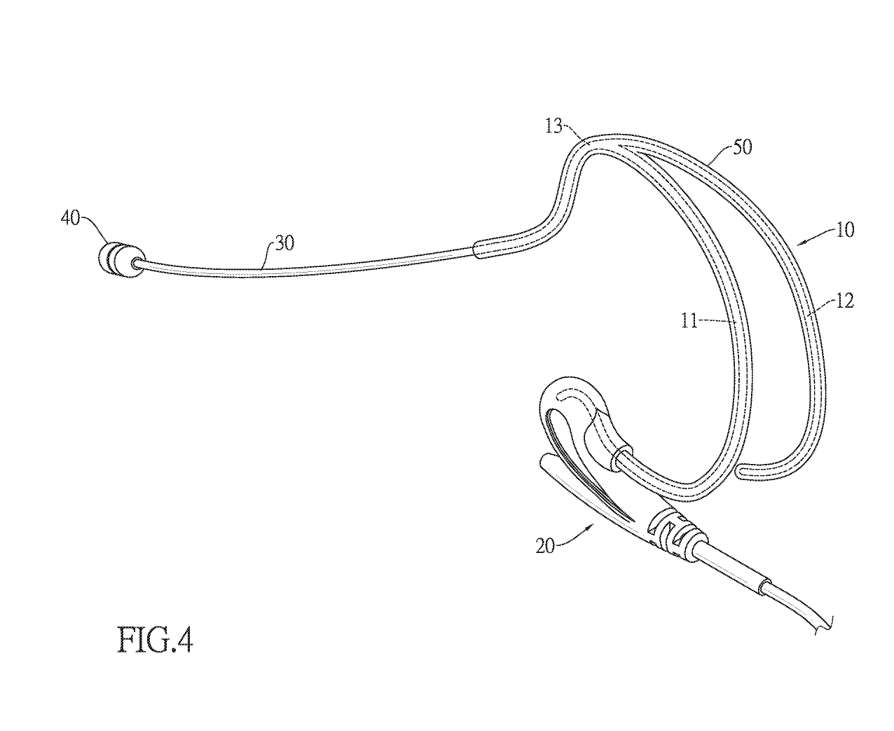

With references to FIGS. 3 and 4, as the user uses the first embodiment of the ear-hook microphone and the ear-hook device thereof in accordance with the present invention, the user pulls the first wire 11 of the ear-hook part 10 away from the second wire 12 of the ear-hook part 10 and hangs the first end 13 of the ear-hook part 10 on the user's ear, allowing the first wire 11 coated with the wire cover 50 and the second wire 12 coated with the wire cover 50 to respectively abut against the user's ear back and head. The ear-hook microphone and the ear-hook device thereof in accordance with the present invention can be hung on the user's ear more stably and the pressure pressed on the user's ear is distributed by respectively abutting the first wire 11 and the second wire 12 against the user's ear back and head. The connecting part 20 is positioned to abut the cavity below the user's lobule. The user can adjust the position of the guide rod 30 and the microphone 40, allowing the microphone 40 to be close to the mouth of the user. The ear-hook microphone as shown in FIG. 3 can be hung on the user's left ear, and the ear-hook microphone as shown in FIG. 4 can be hung on the user's right ear.

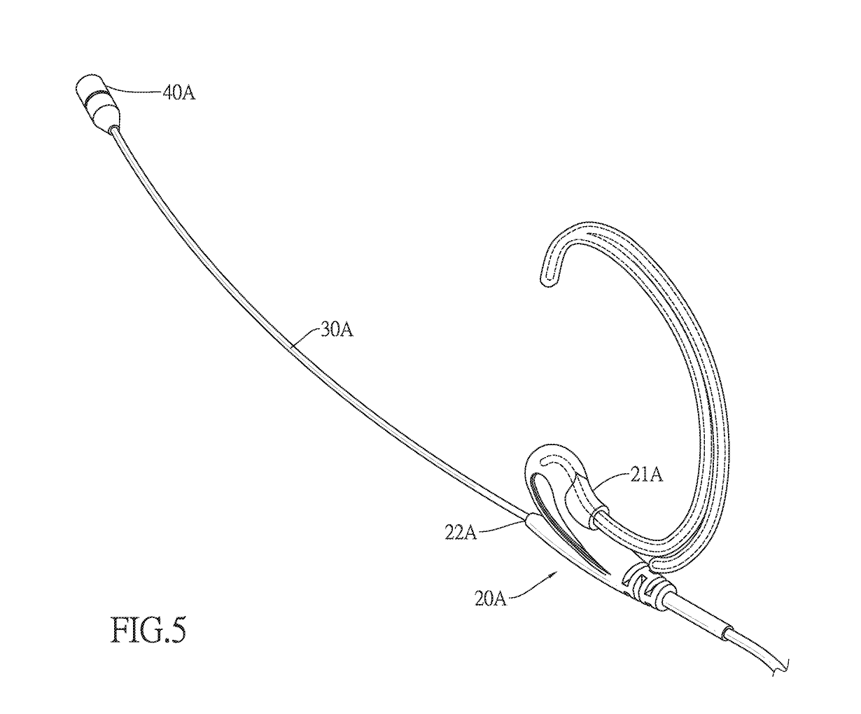

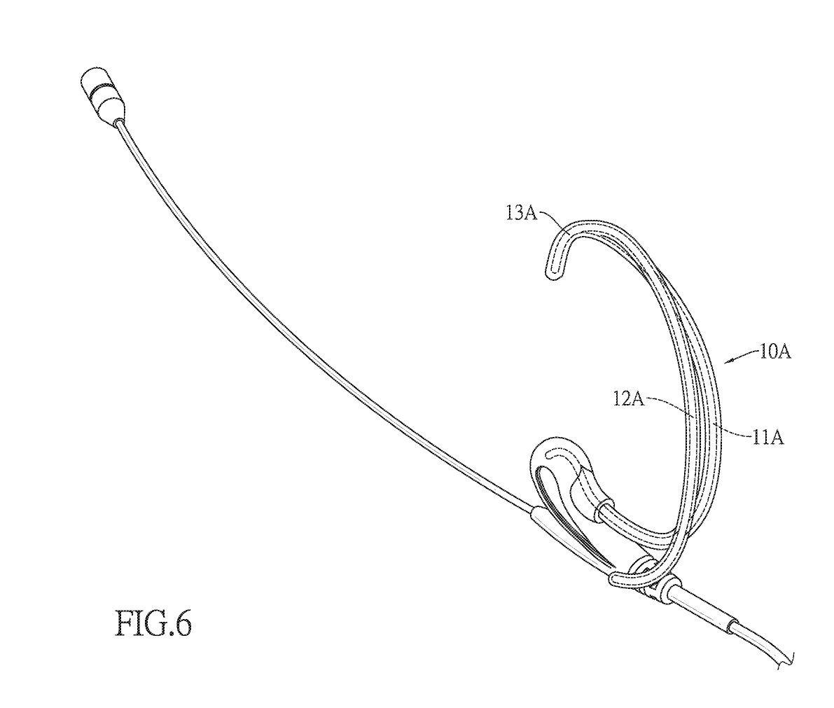

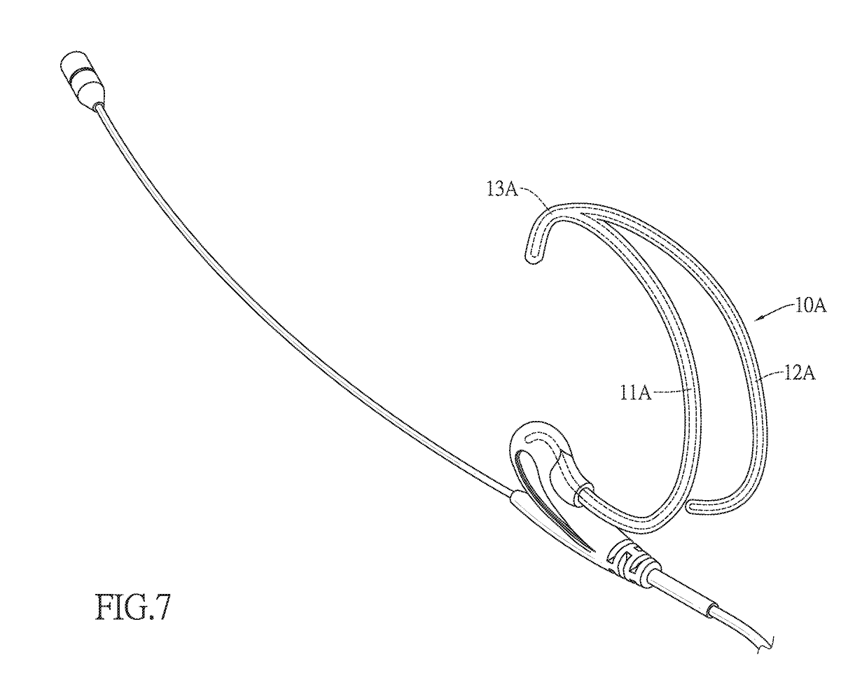

With reference to FIG. 5, a second embodiment of the ear-hook microphone and the ear-hook device thereof in accordance with the present invention is similar to the first embodiment in accordance with the present invention. The differences between the first embodiment and the second embodiment include that a connecting part 20A further comprises a connecting end 22A and the connecting end 22A is adjacent to the penetration end 21A of the connecting part 20A. One end of a guide rod 30A is connected to the connecting end 22A of the connecting part 20A, and a microphone 40A is connected to the other end of the guide rod 30A opposite to the connecting end 22A of the connecting part 20A. With references to FIGS. 6 and 7, the use of the second embodiment of the ear-hook microphone and the ear-hook device thereof is the same as that of the first embodiment of the ear-hook microphone and the ear-hook device thereof in accordance with the present invention. The user pulls the first wire 11A of the ear-hook part 10A away from the second wire 12A of the ear-hook part 10A and hangs the first end 13A of the ear-hook part 10A on the user's ear.

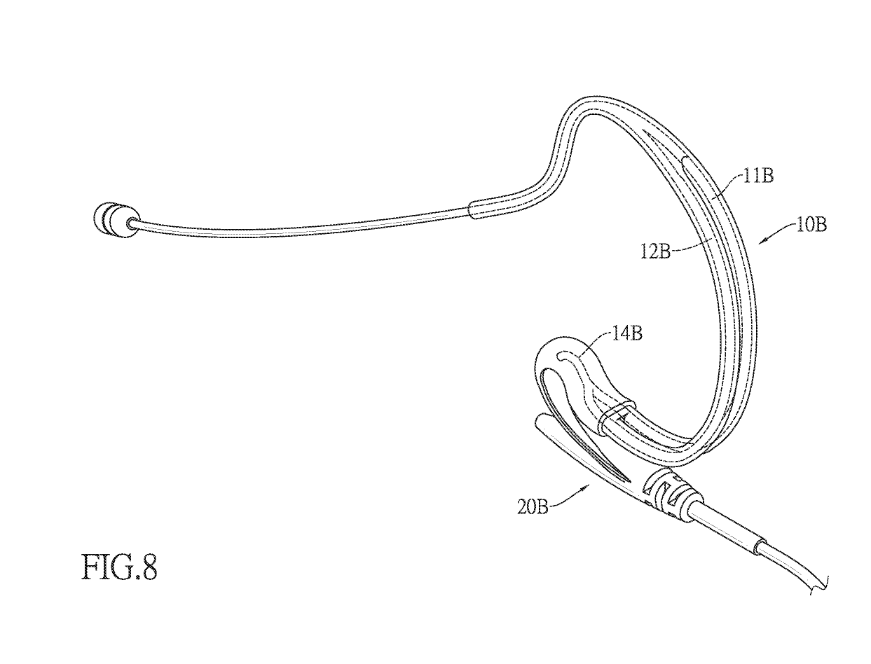

With reference to FIG. 8, a third embodiment of the ear-hook microphone and the ear-hook device thereof in accordance with the present invention is similar to that of the first embodiment in accordance with the present invention. The differences between the first embodiment and the third embodiment include that in the third embodiment, the two ends of the first wire 11B of the ear-hook part 10B are each respectively connected to the two ends of the second wire 12B of the ear-hook part 10B, and the second end 14B of the ear-hook part 10B is coated by the connecting part 20B.

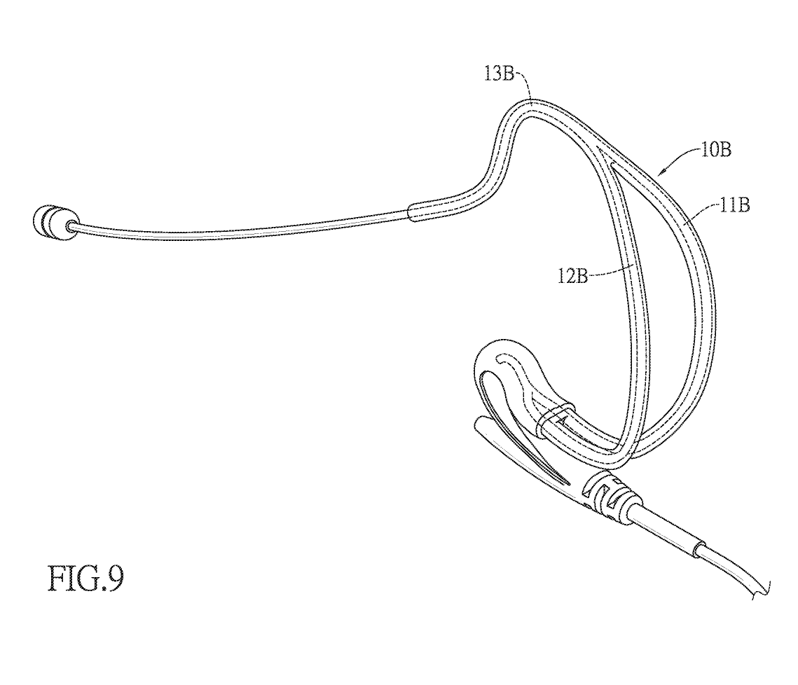

With reference to FIG. 9, the use of the third embodiment of the ear-hook microphone and the ear-hook device thereof is similar to that of the first embodiment of the ear-hook microphone and the ear-hook device thereof in accordance with the present invention. The user pulls the first wire 11B of the ear-hook part 10B away from the second wire 12B of the ear-hook part 10B and hangs the first end 13B of the ear-hook part 10B on the user's ear. The ear-hook microphone and the ear-hook device thereof in accordance with the present invention can be hung on the user's ear more stably and the pressure pressed on the user's ear can be distributed by respectively abutting the first wire 11B and the second wire 12B against the user's ear back and head.

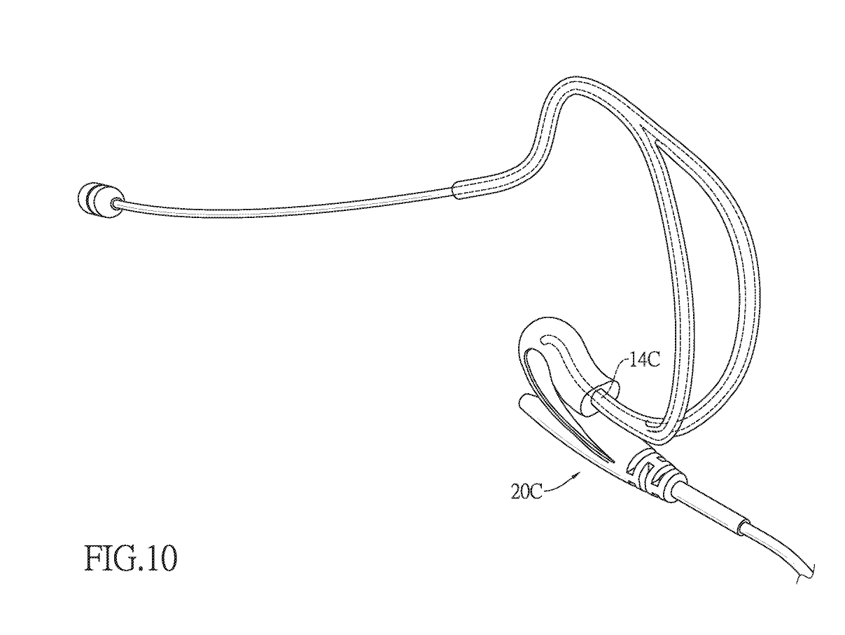

With reference to FIG. 10, a fourth embodiment of the ear-hook microphone and the ear-hook device thereof in accordance with the present invention is similar to that of the third embodiment. The differences between the third embodiment and the fourth embodiment include that in the fourth embodiment, the second end 14C of the ear-hook part 10C is not coated by the connecting part 20C. The use of the fourth embodiment of the ear-hook microphone and the ear-hook device thereof is the same as that of the third embodiment of the ear-hook microphone and the ear-hook device thereof.

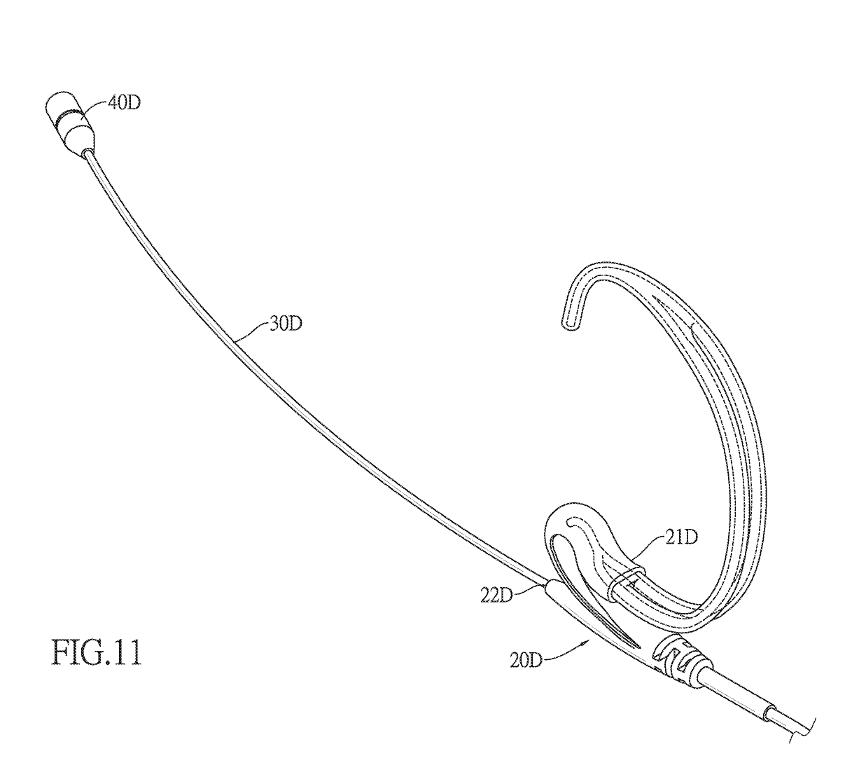

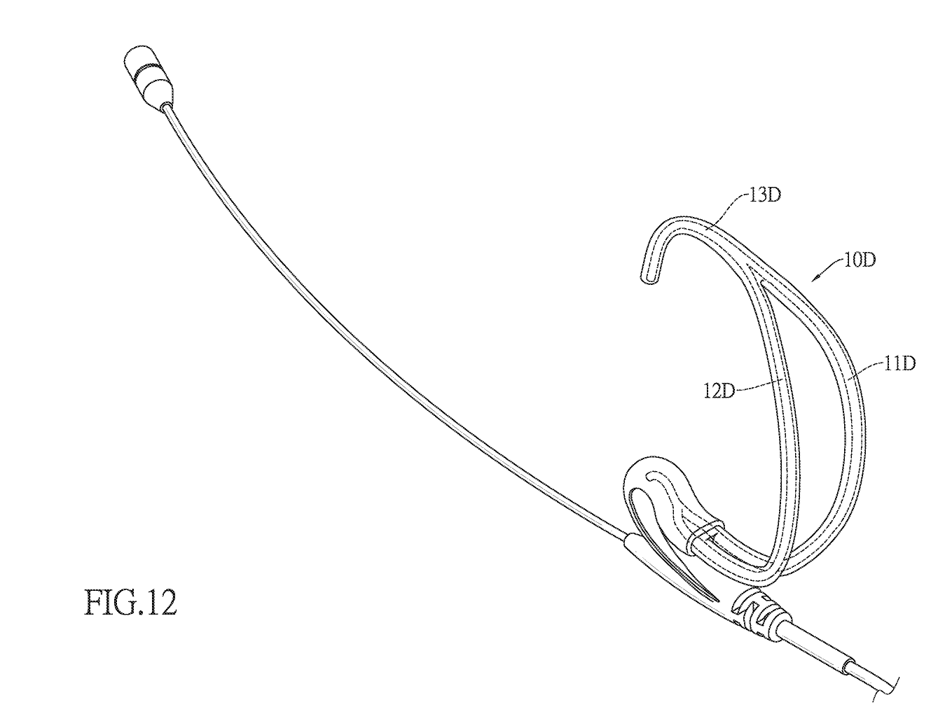

With reference to FIG. 11, a fifth embodiment of the ear-hook microphone and the ear-hook device thereof in accordance with the present invention is similar to that of the third embodiment. The differences between the third embodiment and the fifth embodiment include that in the fifth embodiment, a connecting part 20D further comprises a connecting end 22D, and the connecting end 22D is adjacent to the penetration end 21D of the connecting part 20D. One end of a guide rod 30D is connected to the connecting end 22D of the connecting part 20D, and a microphone 40D is connected to the other end of the guide rod 30D opposite to the connecting end 22D of the connecting part 20D. With reference to FIG. 12, the use of the fifth embodiment of the ear-hook microphone and the ear-hook device thereof is the same as that of the third embodiment of the ear-hook microphone and the ear-hook device thereof. The user pulls the first wire 11D of the ear-hook part 10D away from the second wire 12D of the ear-hook part 10D and hangs the first end 13D of the ear-hook part 10D on the user's ear.

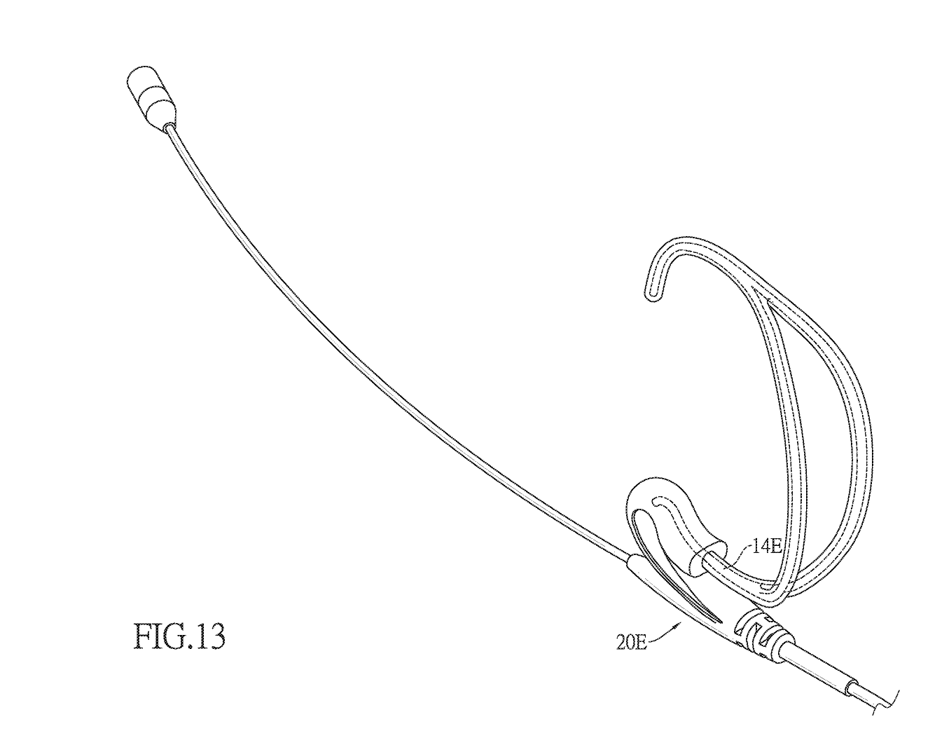

With reference to FIG. 13, a sixth embodiment of the ear-hook microphone and the ear-hook device thereof in accordance with the present invention is similar to that of the fifth embodiment in accordance with the present invention. The differences between the fifth embodiment and the sixth embodiment include that in the sixth embodiment, a second end 14E of an ear-hook part 10E is not coated by a connecting part 20E. The use of the sixth embodiment of the ear-hook microphone and the ear-hook device thereof is the same as that of the fifth embodiment of the ear-hook microphone and the ear-hook device thereof in accordance with the present invention.

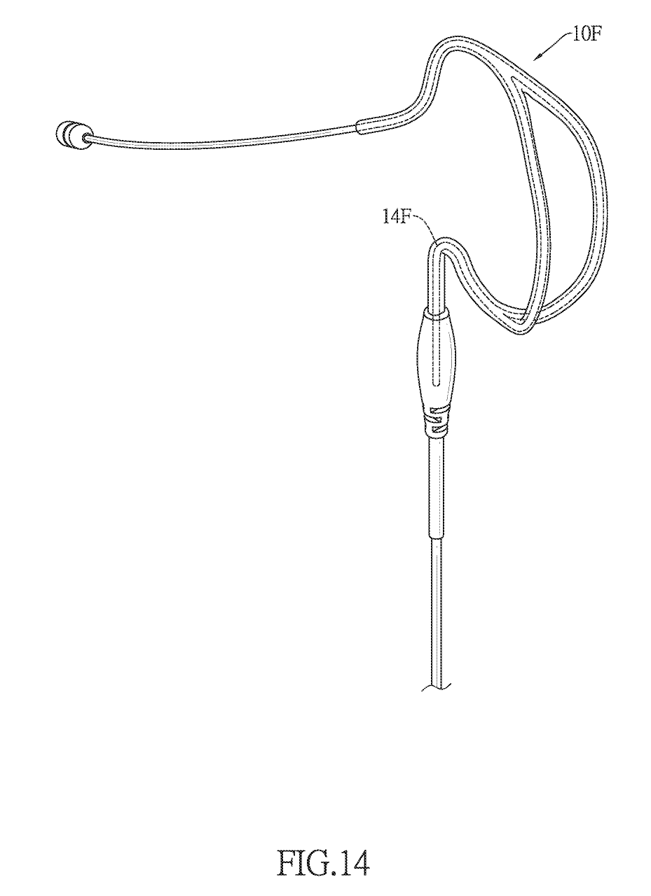

With reference to FIG. 14, a seventh embodiment of the ear-hook microphone and the ear-hook device thereof in accordance with the present invention is similar to that of the fourth embodiment in accordance with the present invention. The differences between the seventh embodiment and the fourth embodiment include that in the seventh embodiment, a second end 14F of an ear-hook part 10F is able to be bent into a hooked form. The use of the seventh embodiment of the ear-hook microphone and the ear-hook device thereof is similar to that of the fourth embodiment of the ear-hook microphone and the ear-hook device thereof in accordance with the present invention. The second end 14F of the ear-hook part 10F is positioned to abut the cavity below the user's lobule.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1-9. (canceled)

10. An ear-hook microphone, comprising
an ear-hook device, comprising
an ear-hook part, comprising
a first wire, which is flexible metal, the first wire having two ends;
a second wire, which is flexible metal, the second wire having two ends, wherein the second wire is adjacent to the first wire;
a first end, wherein the first end of the ear-hook part is formed by one of the ends of the first wire connecting to one of the ends of the second wire of the ear-hook part, and the first end of the ear-hook part is able to be bent into an arc-shaped and hooked form; and
a second end, wherein the other end of the first wire opposite to the first end of the ear-hook part extends to form the second end of the ear-hook part; and
a connecting part, comprising a penetration end, wherein the penetration end is penetrated by the second end of the ear-hook part;
a guide rod; and
a microphone, wherein the microphone is connected to one end of the guide rod, and the other end of the guide rod opposite to the microphone is connected to the first end of the ear-hook part of the ear-hook device.

11. (canceled)

12. The ear-hook microphone as claimed in claim 10, wherein the first wire of the ear-hook part of the ear-hook device is overlapped with the second wire of the ear-hook part of the ear-hook device.

13. The ear-hook microphone as claimed in claim 10, wherein the two ends of the first wire of the ear-hook part of the ear-hook device are each respectively connected to the two ends of the second wire of the ear-hook part of the ear-hook device.

14. The ear-hook microphone as claimed in claim 13, wherein the second end of the ear-hook part of the ear-hook device is coated by the connecting part of the ear-hook device.

15. The ear-hook microphone as claimed in claim 13, wherein the second end of the ear-hook part of the ear-hook device is not coated by the connecting part of the ear-hook device.

16. The ear-hook microphone as claimed in claim 10, wherein the materials of the first wire and the second wire of the ear-hook part of the ear-hook device are flexible metal.

17. The ear-hook microphone as claimed in claim 10, wherein the ear-hook device further comprises a wire cover; the wire cover respectively coats the first wire, the second wire and the first end of the ear-hook part.

18. The ear-hook microphone as claimed in claim 17, wherein the material of the wire cover of the ear-hook device is silicone.

19. The ear-hook microphone as claimed in claim 10, wherein the connecting part of the ear-hook device further comprises a connecting end, and the connecting end is adjacent to the penetration end of the connecting part.
